(19) United States
(12) Patent Application Publication
(10) Pub. No.: US 2010/0131698 A1
(43) Pub. Date: May 27, 2010

(54) MEMORY SHARING METHOD FOR FLASH DRIVER

(76) Inventor: Chien-Liang Tsai, Taipei County (TW)

Correspondence Address: NORTH AMERICA INTELLECTUAL PROPERTY CORPORATION, P.O. BOX 506, MERRIFIELD, VA, 22116, US

(21) Appl. No.: 12/277,269

(22) Filed: Nov. 24, 2008

(51) Int. Cl. G06F 12/02; G06F 12/00

(52) U.S. Cl. 711/103; 711/172; 711/E12.002; 711/E12.008; 711/E12.001

(57) ABSTRACT

A memory sharing method for flash driver includes determining a target memory size corresponding to a target flash driver, and loading a target flash program included in the target flash driver into a stack memory allocated in a specific memory device when an unused size of the stack memory available for data storage is greater than the target memory size. Additionally, the step of determining the target memory size includes determining a specific flash program having a maximum size among a plurality of flash programs included in the target flash driver, and setting the target memory size equal to the maximum size of the specific flash program.

### BACKGROUND

The invention relates to a memory sharing method, and more particularly, to a memory sharing method for loading a flash driver to a stack memory allocated in a static random access memory (SRAM).

In an embedded system, because a flash driver cannot be executed in its own flash memory, the flash driver code needs to be stored and executed in a read-only memory (ROM), static random access memory (SRAM), dynamic random access memory (DRAM), or other flash memories. However, if the flash driver code is stored in the ROM, the flash driver suffers a lack of expandability and results in higher hardware costs. Additionally, many electronic devices do not have DRAM or other flash memories. Therefore, the flash driver code is generally stored and executed in the SRAM.

In the conventional methods storing the flash driver code in the SRAM, one method is to allocate a dedicated SRAM for flash driver, but the hardware cost is higher; another method is to initially store the flash driver code in a hard disk or other external memories and to load program code of the flash driver into the SRAM when a program of the flash driver needs to be executed, and remove (unload) this program code from the SRAM when it is not required to be executed. The above-mentioned second method is useful for saving memory space, but a proper memory allocating method is also required to efficiently save the memory space.

### SUMMARY

According to one embodiment of the claimed invention, a memory sharing method comprises: determining a target memory size corresponding to a target flash driver; and loading a target flash program included in the target flash driver into a stack memory allocated in a specific memory device when an unused size of the stack memory available for data storage is greater than the target memory size. Additionally, the step of determining the target memory size comprises: among a plurality of flash programs included in the target flash driver, determining a specific flash program having a maximum size; and setting the target memory size equal to the maximum size of the specific flash program.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a relationship among a SRAM, a stack memory and a target memory according to one embodiment of the present invention.

FIG. 2 illustrates a diagram determining the size of the target memory.

FIG. 3 is the diagram illustrating different target memory sizes of different flash drivers in the stack memory.

FIG. 4 is a flow chart of a memory sharing method according to one embodiment of the present invention.

### DETAILED DESCRIPTION

Because of the consideration of volume of the electronic device and cost of memories, some electronic devices do not have dynamic random access memory (DRAM). When a flash driver is to be executed, the flash driver code is usually stored in a static random access memory (SRAM) because storing the flash driver code in a read-only memory (ROM) lacks expandability.

Generally speaking, a stack memory is allocated in SRAM for storing variables temporarily. The stack memory size is determined according to the size of all variables generated from executing programs, and more precisely, the stack memory size is capable of storing all variables that could possibly be stored in the stack memory at the same time. Therefore, most of the time, the stack memory is not full and has available memory space. This available memory space is wasted and cannot be used for other programs. According to one embodiment of the present invention, a flash driver code is stored and executed in the stack memory to save on ROM and the SRAM space.

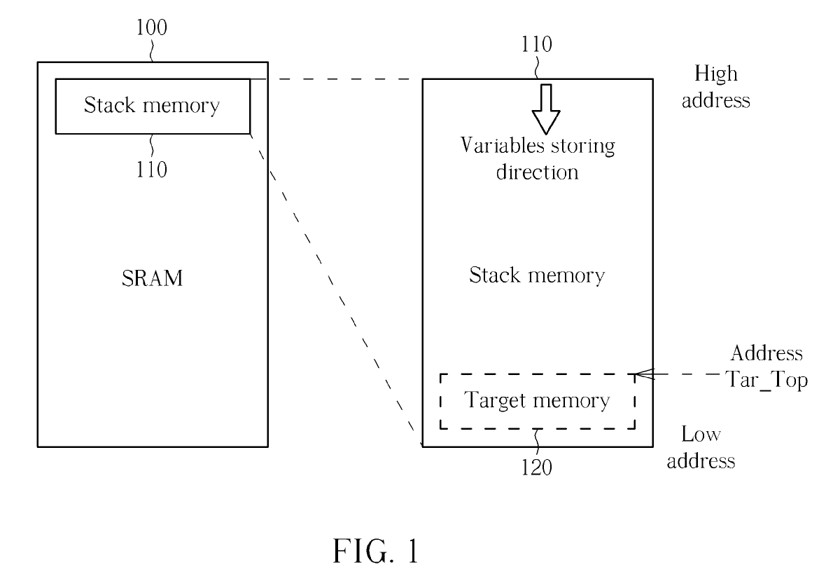

Please refer to FIG. 1. FIG. 1 is a diagram illustrating a relationship among a SRAM 100, a stack memory 110 and a target memory 120 according to one embodiment of the present invention. As shown in FIG. 1, the stack memory 110 is allocated in the SRAM 100 for storing variables generated from executing programs, and the flash driver code is stored in a target memory 120 of the stack memory 110 if the flash driver is required to be executed and the available target memory size is greater than the size of the flash driver code. In this embodiment, when the flash driver is required to be executed, the flash driver code is loaded from other storage device(s) and is stored into the target memory 120 in the stack memory 110, where the target memory is a fixed memory space arranged in the stack memory 110. As shown in FIG. 1, the variables are stored sequentially from a high address to a low address of the stack memory 110 when pushed into the stack memory 110. To prevent influencing the variables storage of other programs, the fixed target memory space for storing the flash driver code 120 is delimited between a predetermined address and a lowest address of the stack memory 110.

However, in practice, the lowest address may be occupied by other special variables or required program code. Therefore, the flash driver code 120 is delimited between the predetermined address and a lowest available address of the stack memory 110.

Additionally, when the variables are stored sequentially from the low address to the low address of the stack memory 110, the target memory for storing the flash driver code 120 is delimited between a predetermined address and an available highest address of the stack memory 110.

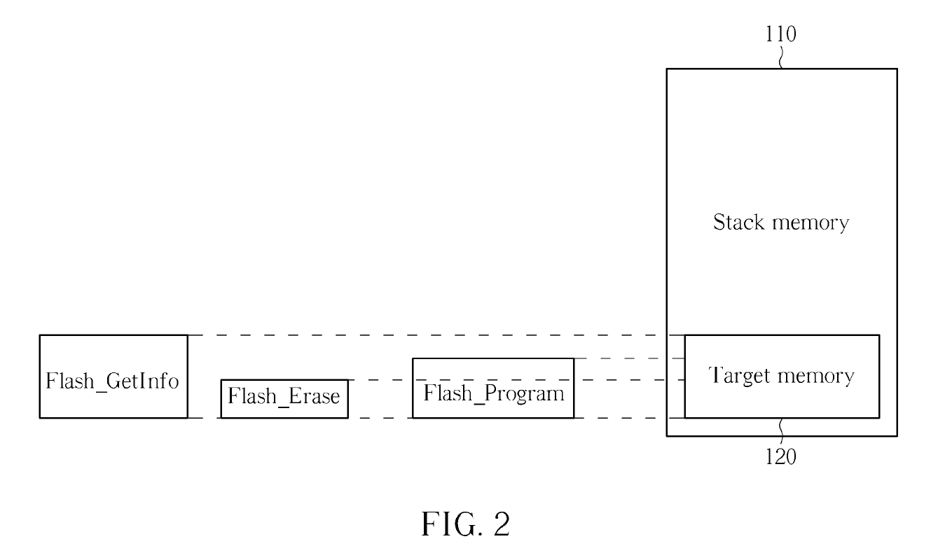

Moreover, the size of the target memory in the stack memory 110 is set equal to the maximum size of one of a plurality of flash program codes, where the plurality of flash program codes respectively perform different functions of the flash driver. FIG. 2 illustrates a diagram determining the size of the target memory. As shown in FIG. 2, the flash driver has three flash programs Flash_GetInfo, Flash_Erase, and Flash_Program. Flash_GetInfo is a flash program for checking the type of the flash memory; Flash_Erase is a flash program for performing an erase operation on a flash memory; and Flash_Program is a flash program for performing a programming operation on the flash memory. The above-mentioned three flash programs are the basic functions of the flash driver, and these flash programs are not executed at the same time. Therefore, setting the target memory size equal to a maximum size of one of a plurality of flash program codes (in this embodiment, Flash_GetInfo has the maximum size) can ensure that each flash program code will be stored into the target space successfully.

However, other flash programs could be added into the flash driver by the designer's consideration, or maybe more flash programs can be executed at the same time. Therefore, the target memory size is determined by comparing the flash program combinations, where each flash program combination includes at least one flash program code, and the flash program(s) included in the flash program combination can be executed at the same time. The target memory size is set equal to a specific flash program combination that has a maximum size.

However, because the flash program code is stored from a top address of the target memory 120 (that is, address Tar_Top shown in FIG. 1), when the size of the loaded flash program is less than the target memory size, the memory space close to the lowest address is wasted and cannot be used by other programs. As shown in FIG. 2, if the Flash_Program is used most often, then for most of the time the target memory is not full because the target memory size determined by the Flash_GetInfo and is greater than Flash_Program code. To solve this problem, the stack memory can set another beginning address for Flash_Program, where the memory size between the beginning address and the lowest available address is equal to the size of Flash_Program code. Therefore, when loading the Flash_Program, more stack memory is released for other programs.

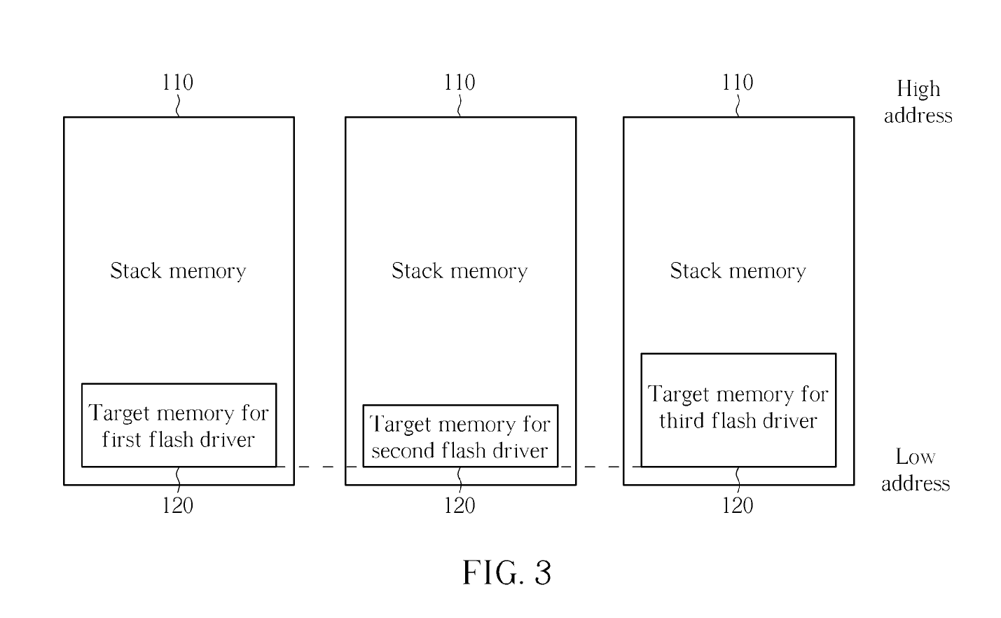

Additionally, because of the considerations of the production management and material preparation, electronic devices may use different flash memories and different flash drivers. Each flash driver has its flash program codes and therefore the target memory size of each flash driver needs to be determined according to the above-mentioned rule for determining the target memory size. When the electronic device is powered on, each flash driver code is loaded to the SRAM to check the type of flash memory. After determining the type of flash driver, the corresponding target memory size is also determined. FIG. 3 is a diagram illustrating different target memory sizes of different flash drivers in the stack memory.

The system loads the flash driver code to the target memory if the available stack memory size is greater than the target memory size. A stack pointer is used to check the available stack memory size. The stack pointer points to the current topmost data (that is, the latest loading data) item in the stack, and whether the flash program can be loaded in the target memory is determined by comparing the stack pointer address and the top address of the target memory (that is, address Tar_Top shown in FIG. 1). Assuming that variables are stored sequentially from a high address to a low address of the stack memory, when the stack pointer address is lower than the top address of the target memory, then the available stack memory size is less than the target memory size, and the flash program is not loaded at this time; when the stack pointer address is greater than the top address of the target memory, then the available stack memory size is enough to load the flash program, and the flash program is loaded into the target memory at this time.

Please note that, loading the flash driver code into the stack memory in the SRAM is merely one exemplary embodiment of the present invention. However, without departing from the spirit of the present invention, the flash driver code can also be loaded into the stack memory in the DRAM or other memories. These alternative designs all fall in the scope of the present invention.

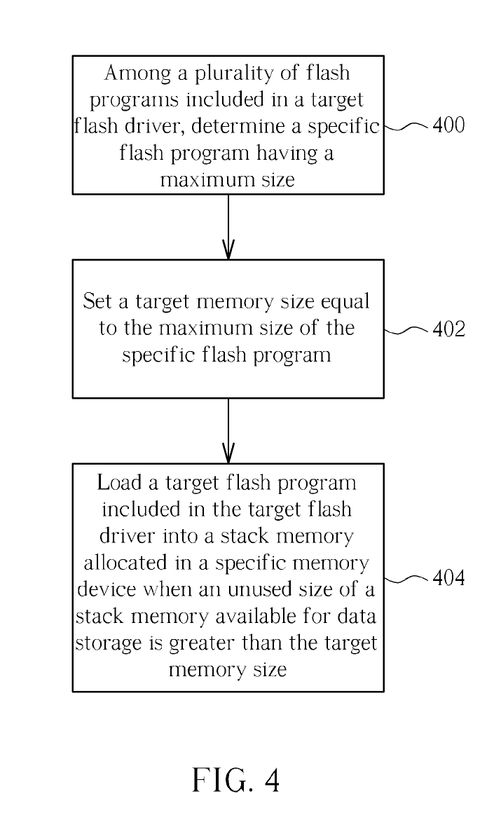

FIG. 4 is a flow chart of a memory sharing method according to one embodiment of the present invention. Referring to the flowchart shown in FIG. 4, the steps of the memory sharing method are described as follows:

Step 400: among a plurality of flash programs included in a target flash driver, determine a specific flash program having a maximum size.

Step 402: set a target memory size equal to the maximum size of the specific flash program.

Step 404: load a target flash program included in the target flash driver into a stack memory allocated in a specific memory device when an unused size of a stack memory available for data storage is greater than the target memory size.

Briefly summarized, the present invention discloses a memory sharing method for storing the flash driver code in a fixed memory space in the stack memory; and the target memory size can be determined by comparing the sizes of the flash program codes and the maximum size among the flash program codes is set as the target memory size.

Those skilled in the art will readily observe that numerous modifications and alterations of the device and method may be made while retaining the teachings of the invention.

What is claimed is:

1. A memory sharing method, comprising:
determining a target memory size corresponding to a target flash driver; and
loading a target flash program included in the target flash driver into a stack memory allocated in a specific memory device when an unused size of a stack memory available for data storage is greater than the target memory size.

2. The method of claim 1, wherein the specific memory device is a static random access memory (SRAM).

3. The method of claim 1, wherein the step of determining the target memory size comprises:
among a plurality of flash programs included in the target flash driver, determining a specific flash program having a maximum size; and
setting the target memory size equal to the maximum size of the specific flash program.

4. The method of claim 3, wherein the flash programs comprises:
a first program, for checking a type of the flash memory;
a second program, for performing an erase operation on a flash memory; and
a third program, for performing a programming operation on the flash memory.

5. The method of claim 3, wherein the step of loading the target flash program comprises:
allocating a memory space in the stack memory, wherein a memory size of the memory space is equal to the target memory size; and
loading the target flash program into the memory space.

6. The method of claim 1, wherein variables are stored sequentially from a high address to a low address of the stack memory when pushed into the stack memory, and the step of loading the target flash program comprises:
loading the target flash program into a fixed memory space in the stack memory.

7. The method of claim 6, wherein the fixed memory space is delimited between a predetermined address and a lowest available address of the stack memory.

8. The method of claim 1, wherein variables are stored sequentially from a low address to a high address of the stack memory when pushed into the stack memory, and the step of loading the target flash program comprises:
loading the target flash program into a fixed memory space in the stack memory.

9. The method of claim 8, wherein the fixed memory space is delimited between a predetermined address and a highest available address of the stack memory.
